(19) United States
(12) Patent Application Publication
(10) Pub. No.: US 2011/0055730 A1
(43) Pub. Date: Mar. 3, 2011

(54) User-Customizable Electronic Virtual Exhibit Reproduction System

(76) Inventors: Ty Joseph Caswell, Zimmerman, MN (US); Andrew Sazama, Savage, MN (US); Jason Andrew Caswell, Elk River, MN (US); Timothy Allen Bohmer, Minneapolis, MN (US)

(21) Appl. No.: 12/869,325

(22) Filed: Aug. 26, 2010

Related U.S. Application Data
(60) Provisional application No. 61/237,206, filed on Aug. 26, 2009.

(51) Int. Cl. G06F 3/01

(52) U.S. Cl. 715/753

(57) ABSTRACT

Methods and systems for delivery of a virtual exhibit are disclosed. In one aspect, a method of delivering a virtual exhibit to an attendee of a physical event includes receiving an indication of interest from an attendee that identifies at least one physical exhibit at an event, the indication of interest including an identifier associated with the attendee. The method further includes storing an association between the attendee and the exhibit, and receiving a request from the attendee to view a virtual event. The method also includes displaying the virtual event to the attendee, the virtual event including a virtual exhibit corresponding to the at least one physical exhibit.

### CROSS-REFERENCE TO RELATED APPLICATIONS

The present application claims the benefit of U.S. Provisional Patent Application No. 61/237,206, entitled “User-Customizable Living Trade Show System”, filed Aug. 26, 2009, the disclosure of which is hereby incorporated by reference in its entirety.

### TECHNICAL FIELD

The present disclosure relates to virtual exhibit presentation systems. In particular, the present disclosure relates to a user-customizable, electronic virtual exhibit reproduction system.

### BACKGROUND

An event such as a conference, a seminar, open house, or a trade show presents a unique networking forum where participants congregate with an intention to exchange ideas and information. In general, it is in the participants' best interest to streamline the exchange of information; however, this presents a unique set of problems for participants who have related yet dissimilar agendas.

For example, in the context of a trade show, an attendee is primarily interested in non-invasively obtaining and holding information from an exhibitor. In contrast, an exhibitor is driven to generate comprehensive demographic information based on attendee interest in products and/or services in a manner that simultaneously caters to attendee sensibilities. Additionally, the exhibitor is interested in interacting with trade show attendees during the trade show, and easing tension or anxiety commonly experienced in a “cold-contact” interaction. Further, both attendees and exhibitors alike wish to conveniently obtain and manage product literature, contact information, and various other information, preferably without having to worry about reviewing that material at the trade show event or other type of event.

In other contexts, the desires of presenters and attendees are similar. For example, in the case of a seminar or other corporate event, a presenter may not necessarily wish to sell a product, but may wish to distribute information to attendees. In these cases as well, the presenter would like to receive feedback regarding which attendees find the information or presentation useful, because that information could lead to further contact or communication regarding topics of interest to the presenter and attendee.

In still further contexts, such as at museums, zoos, or amusement parks, there often are exhibits and associated descriptive information. Typically at such locations, a visitor will view that information, but does not take that information home with them for later review.

Consequently, it is desirable to provide a system that allows such event or attraction attendees to customize their event experience in a manner where that user need not provide substantial input during a trade show itself.

### SUMMARY

In accordance with the following disclosure, the above and other issues are addressed by the following:

In one aspect, a method of delivering a virtual exhibit to an attendee of a physical event includes receiving an indication of interest from an attendee that identifies at least one physical exhibit at an event, the indication of interest including an identifier associated with the attendee. The method further includes storing an association between the attendee and the exhibit, and receiving a request from the attendee to view a virtual event. The method also includes displaying the virtual event to the attendee, the virtual event including a virtual exhibit corresponding to the at least one physical exhibit.

In a second aspect, a method of viewing a virtual exhibit includes attending a physical event at which a plurality of physical exhibits reside, and, while attending the physical event, electronically actuating a communication to an event server, the communication associating an event attendee with the physical exhibit. The method further includes accessing a virtual event in a web application generated by the event server, the virtual event corresponding to the physical event. The method also includes viewing a virtual exhibit associated with the virtual event, the virtual exhibit representing the physical exhibit selected by the communication.

In a third aspect, a method of providing virtual event information to event attendees includes designing, using an event server, a virtual exhibit associated with a physical exhibit, and providing the physical exhibit at a physical event, the physical exhibit including an identifier of the exhibit and visited by event attendees. The method further includes receiving information from the event server describing interactions with the virtual exhibit by the event attendees.

### BRIEF DESCRIPTION OF THE DRAWINGS

FIG. 1 illustrates a physical event location at which user selections can be made, according to a possible embodiment of the present disclosure;

FIG. 2 illustrates a network in which a virtual event can be provided, according to a possible embodiment of the present disclosure;

FIG. 3 is a block diagram illustrating example physical components of an electronic computing device useable to implement the various methods and systems described herein;

FIG. 4 is a flowchart of methods and systems for generating a computer-generated event, according to a possible embodiment of the present disclosure;

FIG. 5 is a flowchart of methods and systems for viewing a virtual exhibit by an event attendee, according to a possible embodiment of the present disclosure;

FIG. 6 is a flowchart of methods and systems for managing a virtual event by an exhibitor, according to a possible embodiment of the present disclosure;

FIG. 7 illustrates a user interface presenting a virtual reproduction of an event generated from user selections at the event, according to a possible embodiment of the present disclosure;

FIG. 8 illustrates a user interface presenting a virtual exhibit included in the virtual reproduction of the event, according to a possible embodiment of the present disclosure;

FIG. 9 illustrates a user interface presenting a virtual reproduction of an event generated from user selections at the event, according to a further embodiment of the present disclosure;

FIG. 10 illustrates a user interface presenting a virtual exhibit included in the virtual reproduction of the event, according to a further possible embodiment of the present disclosure;

FIG. 11 illustrates a user interface presenting information accessible from a virtual exhibit, according to a possible embodiment of the present disclosure;

FIG. 12 illustrates a user interface presenting an exhibitor contact management system, according to a possible embodiment of the present disclosure; and

FIG. 13 illustrates the user interface of FIG. 12, including an additional contact validation information screen, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to a user-customizable exhibit reproduction system. The system according to various embodiments, allows an exhibit or event attendee to select a plurality of exhibits from among a group of exhibits available at an event location. The event attendee can then, after the event, view a virtual representation of that event on a computing system, such as through a web interface. Concurrently, and as the event attendee views that information made available for access after the event, the event presenter (e.g., an exhibitor) can validate that one or more attendees view or interact with the virtual exhibit or associated information, thereby gaining knowledge that those attendees have interest

In the context of the present disclosure, an event generally can include any one-time, recurring, or generally constant location or occurrence of interest, such as a trade show, a conference, seminar room, or open house, as well as a zoo, museum, concert, or amusement park. An exhibit generally refers to a particular topic of interest at the event, such as a trade show exhibit, a corporate event, seminar, or a particular conference room or classroom, a particular exhibit at a zoo, amusement park, or museum. The system is denoted as a “living” exhibit replication system in that it correlates a physical, in-person event to a computer generated, user-customizable replication of that event (or a portion thereof). The living event replication system allows a physical, in-person event to be persisted and replicated in computer-generated form as a virtual event. The exhibit replication system also allows the user to view, via a web interface, a living, user-customized version of the event by navigating through a computer-generated event layout. The event replication system operates from a server capable of managing and constructing computer-generated event layouts unique to each event or attendee.

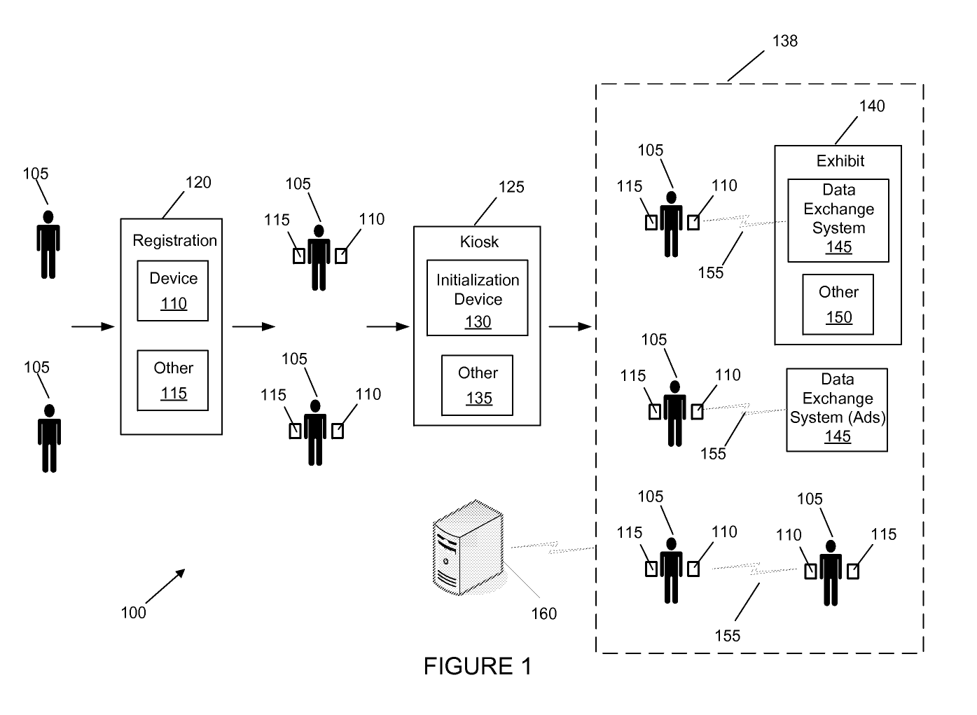

In FIG. 1, an example physical event environment 100 is shown. The example event environment can be, in various embodiments, a physical trade show floor, a seminar, a real estate open house, an exhibition or presentation location, or other in-person event location.

In the example embodiment, the event environment 100 is attended by a plurality of event attendees 105 that register at a registration area 120. Each event attendee 105 has an associated communication device 110 capable of some type of electronic communication (e.g., with a data exchange system, such as data exchange systems 145 as discussed below). In certain embodiments, the communication device 110 can correspond to a cellular telephone (e.g., a smartphone) or other mobile communication device capable of electronic communication, and optionally capable of capturing electronic images (to be used as discussed below). In alternative embodiments, the attendees 105 are issued a communication device at the registration area capable of wireless or wired electronic communication with other computing devices. Example personal communications devices are described in U.S. patent application Ser. No. 12/024,349, filed Feb. 1, 2008, and U.S. patent application Ser. No. 12/251,251, filed Oct. 14, 2008, both entitled “Personal Information Communication Device and Method”, the disclosures of both of which are hereby incorporated by reference in their entireties. In certain embodiments, attendees 105 are issued various other materials 115 at a registration area 120 of the event environment 100.

In some embodiments, the communications device 110 is uniquely associated with a user, for example by using a particular identification code (e.g., a user's phone number, in the case of use of a phone) or a unique identifier assigned to that user (e.g., a registration code associated with the event attendee at the registration area). Other associations between the user and device are possible as well.

In certain embodiments, attendees 105 proceed with the communication device 110 to a kiosk 125 that includes an initialization device 130 and optionally other features 135 (e.g., phone, power outlets). In such embodiments, a plurality of kiosks 125 is provided throughout the event environment 100. In general, the initialization device 130 can be used to activate and initialize a communications device 110 for each respective attendee 105 for the current event, or to associate a particular communications device with a user, with an event.

In alternative embodiments, the kiosks 125 can be replaced by data exchange units, which are placed at the event and designated for use in linking a user identity (or identification assigned to the user) to a user identification code assigned to the issued communication device. In still further embodiments, no such kiosk is required, for example in cases where association of a communication device occurs at the registration area 120. Further, no kiosk or data exchange units may be used by an attendee if that attendee elects to use cellular telephones or other communications devices with which they are already preregistered and preassociated.

Event environment 100 additionally includes a primary event area 138 having one or more exhibit locations 140. In certain embodiments, each of the exhibit locations 140 includes a data exchange system 145 and various other materials 150 (e.g., promotional or informational materials). In the described embodiments, a respective communications device 110 is utilized to exchange information with the data exchange system 145 via a communication link 155. The data exchange system 145 can be, in certain embodiments, associated with a trade show exhibitor. Additional details regarding data exchange systems, and methods of communication between data exchange systems and communication devices, are provided in U.S. patent application Ser. No. 12/579,135, filed Oct. 14, 2009, the disclosure of which is hereby incorporated by reference in its entirety.

In certain embodiments, multiple data exchange systems 145 can be dispersed throughout the event location (e.g., the trade show floor, such as in booths, class registration areas, seminar rooms, etc.) to allow attendees to select one or more exhibits by associating the attendee's communication device (and therefore the attendee) with a unique identifier code of the exhibit.

In such embodiments, each of the data exchange systems 145 associated with a different exhibit has a unique identification number or identifier. An attendee can use his/her communications device to communicate with to a selected number of the data exchange systems, as that attendee desires. In such embodiments, this communication can take any of a number of forms. For example, in some embodiments, the user causes communication of the identifier of their communication device to the data exchange system, for example based on transmission to an internet address of the data exchange system or based on a point-to-point communication method (e.g., infrared or directional RF wireless communication).

In such embodiments, the data exchange systems 145 can be configured to cache collected identifiers from attendees 105 for later connection to server database or transmit collected identifier codes to a virtual event server 160 upon receipt, for storage in a database (i.e., wirelessly) along with the identifier of the data exchange system 145 that collected the attendee identifier.

Optionally in such embodiments, a visual trigger can be displayed on a display associated with the data exchange system 145 upon user transmission of his/her identifier to that system, so the attendee knows that their information was transmitted.

In alternative embodiments, the user initiates an exhibit-selecting communication by transmitting data directly to a remote server, such as the event server 160 discussed below. In such embodiments, the communication can take a number of forms. For example, in some situations a unique graphical identifier associated with that exhibit, such as a one-dimensional or two-dimensional bar code that is preassociated with the exhibit at the event server 160. In such embodiments, a communications device 110 having electronic image capture capabilities (e.g., a smartphone with an integrated camera) would be used. In such embodiments, it is the communications device 110 that captures information and transmits that information to an event server 160 (as opposed to communication from the event server 160 from the data exchange system 145, or some combination of the data exchange system 145 and communications device 110). In such embodiments, these images can be managed using an application provided for use on a cellular telephone, such as an iPhone from Apple Corporation of Cupertino, Calif., or a phone running the Android mobile operating system provided by Google, Incorporated, of Mountain View, Calif.

In still a further example, users having a cellular telephone can elect to log in to a mobile application (e.g., an installable platform-specific application or a web-based platform-generic mobile application) to enter or select an identifier of the exhibit (e.g., by exhibit number or name), thereby associating that user with the exhibit. In such an embodiment, the attendee's log in information can include an event-specific activation code the attendee would enter into the application to associate the attendee 105 and communication device 110 with the event 100.

In still further alternatives, other communications media, such as data or SMS services provided on cellular telephones, smartphones, or tablet devices are useable as well to transmit identifiers to a published internet address or number associated with the data exchange device 145 or exhibit, and can be transmitted either to the data exchange device or directly to an event server 160.

In still other embodiments, the event attendee 105 does not need to use a communications device 110. In such embodiments, the attendee can identify him or herself at each event exhibit by using a keypad, touchscreen, or other input device associated with a data exchange device 145 to enter a unique identifier for that attendee (e.g., name, identification code, or other identifier). This identifier can then be linked to the event exhibit at the virtual event server 160 for display of a living, persisted event (e.g., a computer-generated recreation of the physical event) to that attendee, as described below.

Referring now to the overall event environment 100, and in particular the primary event area 138, the data exchange systems 145 can include displays, which could display an image representing a picture of a virtual exhibit (e.g., a virtual trade show booth or seminar class). The display could also display information from the exhibit (e.g., an informational flyer, multimedia presentation, or other materials). In still further examples, the display could display an image of an identifier of the exhibit, for example an exhibit number, or an identification symbol such as a one-dimensional or two-dimensional bar code (e.g., to provide the identification code to those users employing the image capture or web application selection techniques discussed above). Other information can be presented on the display as well.

Additionally, a communications device 110 can be used to exchange information with a data exchange system 145 that is not associated with an exhibit location 140, such as a data exchange system managed and associated by an advertiser not otherwise present at the event. The advertiser may choose to distribute literature without having a dedicated exhibit location, and may distribute games or sweepstakes entries via the data exchange system 145. Further, a communications device 110 is utilized to exchange information with other attendees in an intra-communications device information transaction via the communication link 155.

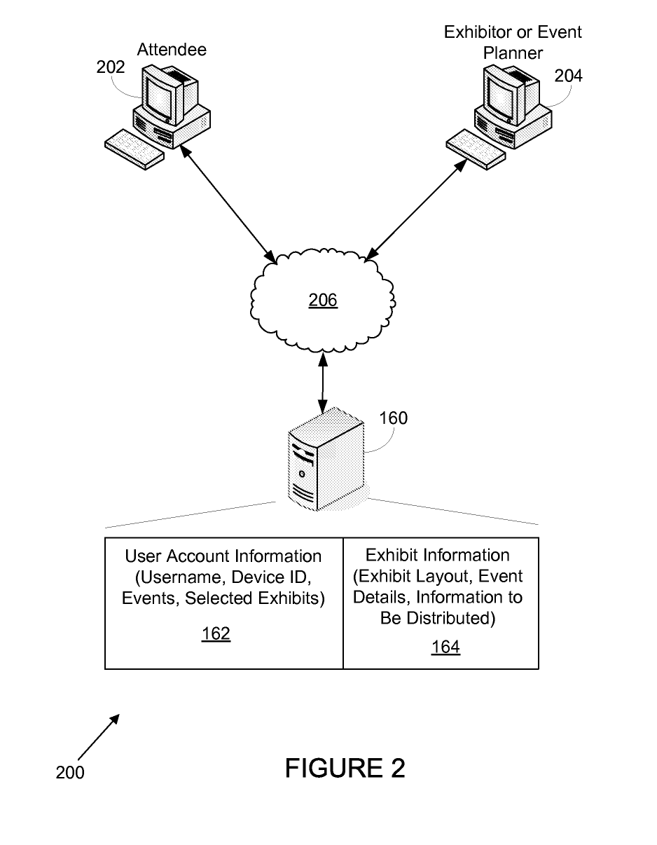

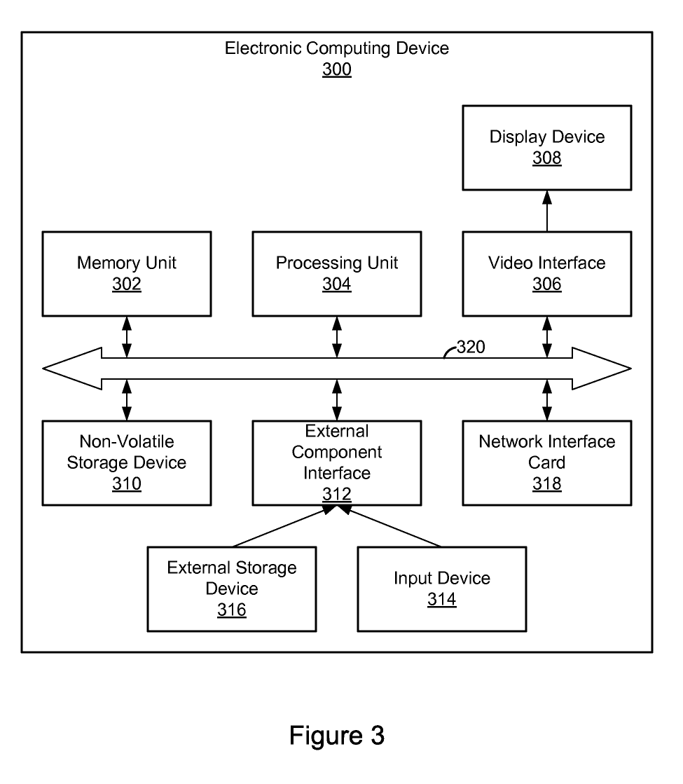

In preferred embodiments, an event attendee 105 can visit a number of exhibit locations 140 and cause a data exchange operation using any of the above-described techniques. These communications are transmitted from communications devices and data exchange devices to an event server 160. The event server 160 provides a web connection on a wide area network (e.g., the Internet) for distribution of information to attendees, including display of a virtual event environment such as the one depicted in FIGS. 2-3, below. Each time an attendee 105 at the physical event environment 100 selects an exhibit using one of the above-described data exchange operations, he or she “collects” that event exhibit, indicating that the attendee has interest in the exhibit and would like to include it in their living, computer-generated event (to be persisted and viewed after the physical event).

The event server 160 receives information from the one or more exhibits for the event, as well as information regarding the specific exhibits selected by the attendee 105. The event server 160 compiles all the exhibit identifiers “collected” by the attendee by either communication with the data exchange systems 145 of relevant exhibits locations 140 or otherwise collected by the user/attendee by communication of an identifier of the exhibit to the event server 160. These exhibit identifications are collected by the event server 160 in an account specifically for that attendee 105. In certain embodiments, a web-based application can be provided to attendees for use in viewing their own personal event they gathered based on the subset of exhibits actually selected by that attendee.

In certain embodiments, the attendee's account on the event server 160 accepts each one of the user selections (e.g., corresponding to exhibits) in the order they were collected, thus retaining the order of exhibits visited. For example, an attendee 105 can walk through an event and select, for example 8 of the 12 exhibits located at that event. In such a circumstance, identifiers for those eight exhibits are collected at the event server 160 as associated with the user, and materials or information relating to those eight exhibits can be presented to the user in an arrangement to appear as a recreated event (e.g., a recreated “virtual” event), as illustrated below.

In various embodiments, the event server 160 can be associated with a plurality of events, or more than one event server 160 can be associated with a particular event or attraction.

Referring now to FIG. 2, an example network 200 is illustrated in which the event server 160 can reside, for example for receiving information and information requests from event coordinators, exhibitors and attendees of an event, and for generating persisted (“living”) post-event information for both exhibitors and attendees. Example network 200 represents communication with the event server 160 either before or after an event such as the one depicted in FIG. 1, above.

In the embodiment shown, an attendee 202 and an exhibitor 204 are communicatively connected to the event server 160 via a network 206, such as the Internet.

The event server 160 stores attendee account information 162 and exhibit information 164, associated and editable by the attendee and exhibitor, respectively. The attendee account information 162 includes information associated with the attendee, for example including the attendee's name, contact information, and other personal detail information. The attendee account information 162 also includes information linking the attendee to one or more communications devices (e.g., the identification code of the communications device, or phone number of the attendee), as well as particular actions taken with respect to one or more events, including events attended, exhibits selected for later review at each event, and other information. In certain embodiments, the attendee account information 162 also includes information regarding the location of the event or an extrapolated location of the attendee at the event based on timing of data exchange operations, as discussed above.

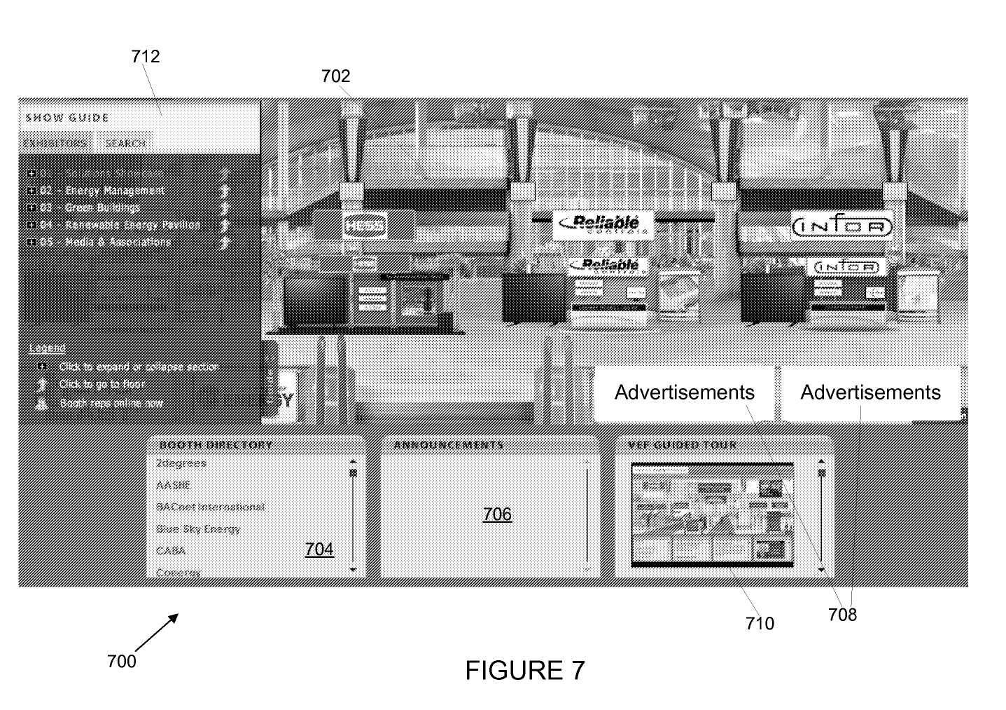

The exhibit information 164 is received from an exhibitor or event planner, and can include definition information regarding an exhibit (e.g., as received from an exhibitor 204), as well as account or specific information regarding the exhibitor or event planner associated with the exhibit. For example, and as previously discussed, the exhibit information 164 can include exhibitor-provided layout information describing the layout of a virtual version of an exhibit; event details, product or attraction informational literature, and other information. The exhibit information 164 can be presented to an attendee, for example using the interfaces of FIGS. 7-11, below, upon accessing that information following a data exchange operation by that attendee and associated with that exhibitor.

After the event occurs and the attendee 105 has selected one or more exhibits, the attendee 202 (which can be the same individual or a group of individuals) can access the event server 160, and is provided with a display of information associated with that attendee. The display provides a virtual listing of events attended by the attendee, as well as a virtual representation of the event including a virtual representation of each of the exhibits selected by the attendee. Various representations of such a virtual event and virtual exhibits are possible; example virtual representations are provided in FIGS. 7-10. Generally, the appearance of a virtual exhibit and the information provided by the exhibit can be defined by the exhibitor 204 in the exhibitor information 164, before, during, or after the event takes place. Because, in this embodiment, the association between the attendee and selected exhibits can be stored in the attendee account information 162 the order in which the user/attendee selected the exhibits, those attendees 202 will be able to ‘view’ the specific exhibits they collected (e.g., 190 out of total 800 booths at a trade show or conference, or some other subset of exhibits based on the particular type of event with which the event server is used) in the order in which they were selected, or in other sorted orders as illustrated in FIGS. 7-11.

Generally, and as illustrated in the examples provided below, each virtual exhibit can include, as illustrated below, information regarding the exhibit, contact information from individuals associated with the exhibit, and other information. The specific information associated with an exhibit will generally differ based on the type of event and the type of exhibit provided. In the case of a trade show, the exhibit may be a trade show booth, and the trade show exhibitor may elect to distribute marketing or promotional materials. In the case of a seminar or other informational class, educational or reference materials may be associated with the virtual exhibit. Corresponding information and contact information can be provided in the case of other corporate events, open houses, or more permanent attractions, such as a zoo, museum, amusement park, or other location.

In certain embodiments, information associated with a particular event (e.g., which exhibits associated with that event the attendee selected) will be associated with the attendee 202 in the event server 160 and accessible to the attendee 202 for a predetermined amount of time after that event (e.g., 90 days), after which such data will expire and be disassociated with the user account.

Concurrently, when an attendee 202 accesses their account on the event server 160 to view exhibit information, the event server 160 is configured to track the access occurrences by that attendee. This information can be stored in the attendees account, and can periodically be collected into reports for the particular event or exhibit of interest. For example a list of attendees can be generated who accessed the information associated with a particular exhibit at an event or on a particular date. This information can be provided by the event server 160 to exhibitors or event planners to allow those users to assess interest in particular exhibits.

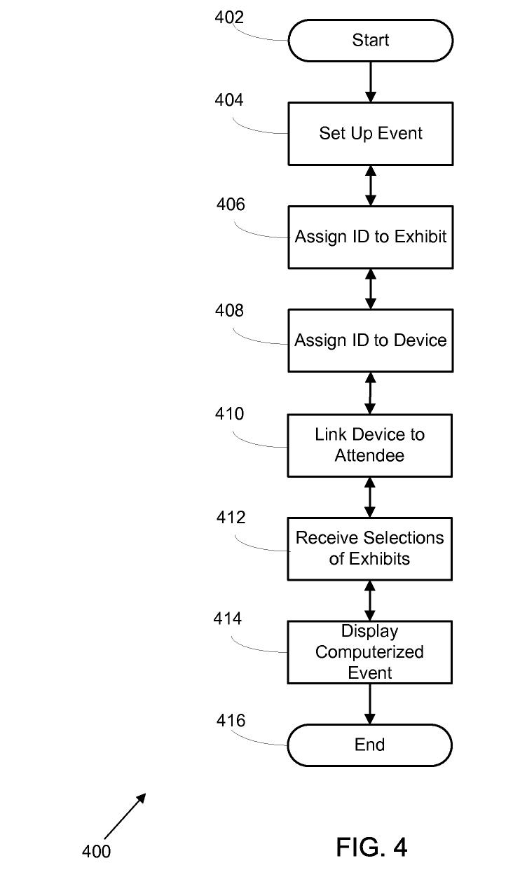

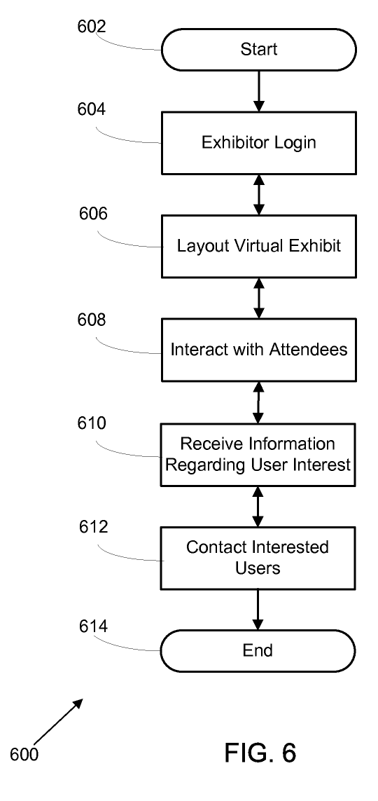

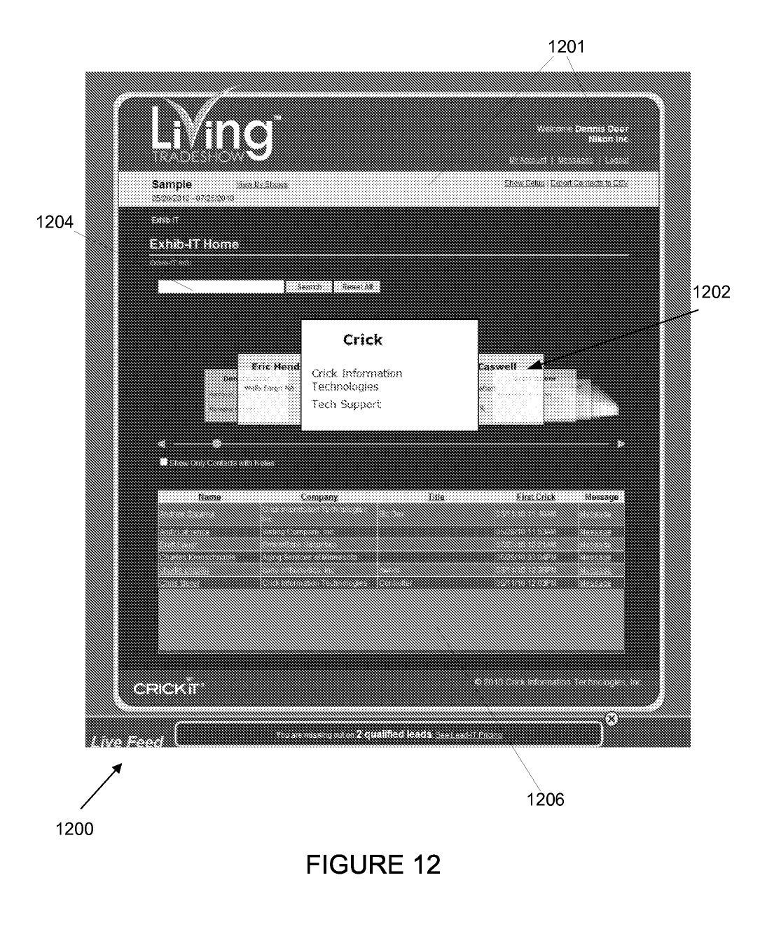

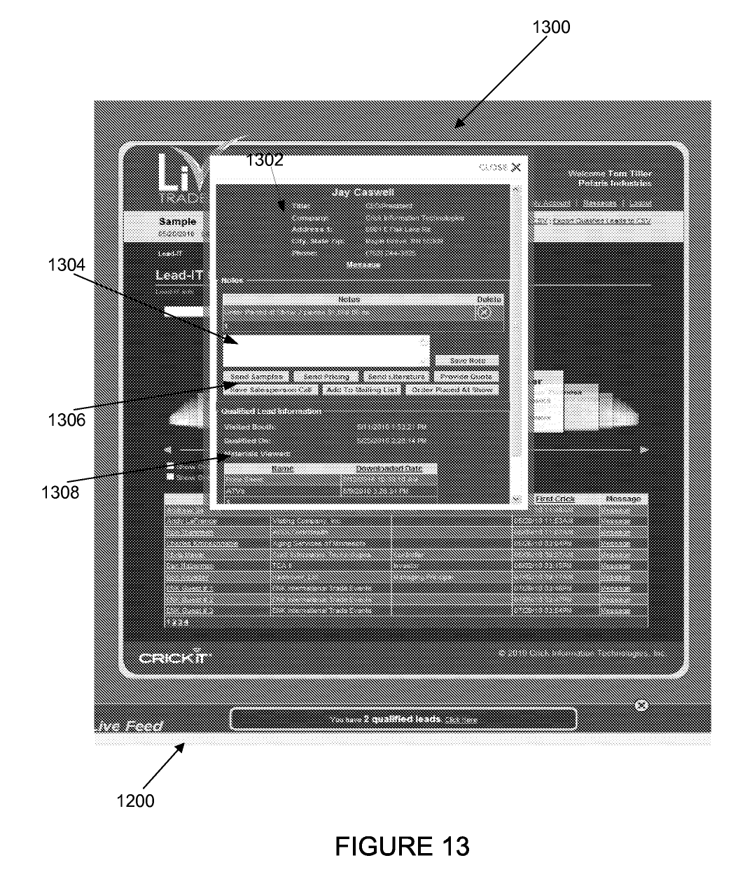

In certain embodiments, the user account information 162 includes information regarding occurrences of accessing the exhibit information by an attendee, for example to track which exhibits the attendee has expressed interest. This information can be presented to the exhibitor or event planner 204 to provide feedback regarding the popularity of exhibits, or to allow follow-on contacts of that attendee in the case of a trade show or other sales environment. An example method for providing this information to exhibitors is discussed below in connection with FIGS. 4 and 6, and example user interfaces allowing an exhibitor 204 to review attendee access are discussed in connection with FIGS. 12-13, below.

FIG. 3 is a block diagram illustrating example physical components of an electronic computing device 300, which can be used to execute the various operations described above. In certain embodiments, the electronic computing device 300 can represent the event server 160 discussed above, or other computing systems used by various users of the system (e.g., exhibitors or attendees).

A computing device, such as electronic computing device 300, typically includes at least some form of computer-readable media. Computer readable media can be any available media that can be accessed by the electronic computing device 300. By way of example, and not limitation, computer-readable media might comprise computer storage media and communication media.

As illustrated in the example of FIG. 3, electronic computing device 300 comprises a memory unit 302. Memory unit 302 is a computer-readable data storage medium capable of storing data and/or instructions. Memory unit 302 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 300 comprises a processing unit 304. As mentioned above, a processing unit is a set of one or more physical electronic integrated circuits that are capable of executing instructions. In a first example, processing unit 304 may execute software instructions that cause electronic computing device 300 to provide specific functionality. In this first example, processing unit 304 may be implemented as one or more processing cores and/or as one or more separate microprocessors. For instance, in this first example, processing unit 304 may be implemented as one or more Intel Core 2 microprocessors. Processing unit 304 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 304 may be implemented as an ASIC that provides specific functionality. In a third example, processing unit 304 may provide specific functionality by using an ASIC and by executing software instructions.

Electronic computing device 300 also comprises a video interface 306. Video interface 306 enables electronic computing device 300 to output video information to a display device 308. Display device 308 may be a variety of different types of display devices. For instance, display device 308 may be a cathode-ray tube display, an LCD display panel, a plasma screen display panel, a touch-sensitive display panel, a LED array, or another type of display device.

In addition, electronic computing device 300 includes a non-volatile storage device 310. Non-volatile storage device 310 is a computer-readable data storage medium that is capable of storing data and/or instructions. Non-volatile storage device 310 may be a variety of different types of non-volatile storage devices. For example, non-volatile storage device 310 may be one or more hard disk drives, magnetic tape drives, CD-ROM drives, DVD-ROM drives, Blu-Ray disc drives, or other types of non-volatile storage devices.

Electronic computing device 300 also includes an external component interface 312 that enables electronic computing device 300 to communicate with external components. As illustrated in the example of FIG. 3, external component interface 312 enables electronic computing device 300 to communicate with an input device 314 and an external storage device 316. In one implementation of electronic computing device 300, external component interface 312 is a Universal Serial Bus (USB) interface. In other implementations of electronic computing device 300, electronic computing device 300 may include another type of interface that enables electronic computing device 300 to communicate with input devices and/or output devices. For instance, electronic computing device 300 may include a PS/2 interface. Input device 314 may be a variety of different types of devices including, but not limited to, keyboards, mice, trackballs, stylus input devices, touch pads, touch-sensitive display screens, or other types of input devices. External storage device 316 may be a variety of different types of computer-readable data storage media including magnetic tape, flash memory modules, magnetic disk drives, optical disc drives, and other computer-readable data storage media.

In the context of the electronic computing device 300, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 302, non-volatile storage device 310, or external storage device 316, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 300.

In addition, electronic computing device 300 includes a network interface card 318 that enables electronic computing device 300 to send data to and receive data from an electronic communication network. Network interface card 318 may be a variety of different types of network interface. For example, network interface card 318 may be an Ethernet interface, a token-ring network interface, a fiber optic network interface, a wireless network interface (e.g., WiFi, WiMax, etc.), or another type of network interface.

Electronic computing device 300 also includes a communications medium 320. Communications medium 320 facilitates communication among the various components of electronic computing device 300. Communications medium 320 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 320, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 300 includes several computer-readable data storage media (i.e., memory unit 302, non-volatile storage device 310, and external storage device 316). Together, these computer-readable storage media may constitute a single data storage system. As discussed above, a data storage system is a set of one or more computer-readable data storage mediums. This data storage system may store instructions executable by processing unit 304. Activities described in the above description may result from the execution of the instructions stored on this data storage system. Thus, when this description says that a particular logical module performs a particular activity, such a statement may be interpreted to mean that instructions of the logical module, when executed by processing unit 304, cause electronic computing device 300 to perform the activity. In other words, when this description says that a particular logical module performs a particular activity, a reader may interpret such a statement to mean that the instructions configure electronic computing device 300 such that electronic computing device 300 performs the particular activity.

One of ordinary skill in the art will recognize that additional components, peripheral devices, communications interconnections and similar additional functionality may also be included within the electronic computing device 300 without departing from the spirit and scope of the present invention as recited within the attached claims.

Referring now to FIGS. 4-6, flowcharts of methods and systems for operation and usage of the systems disclosed above are provided.

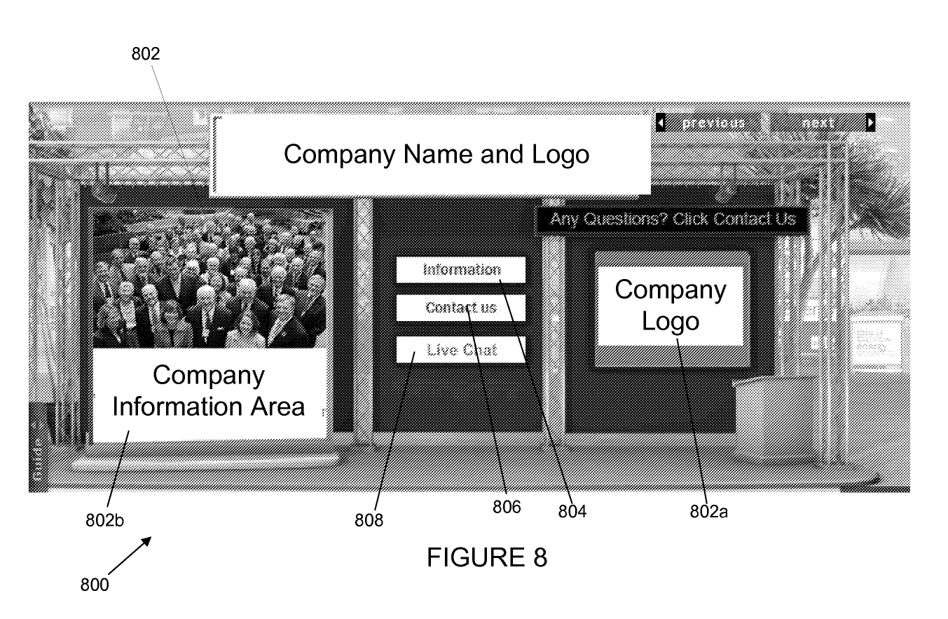

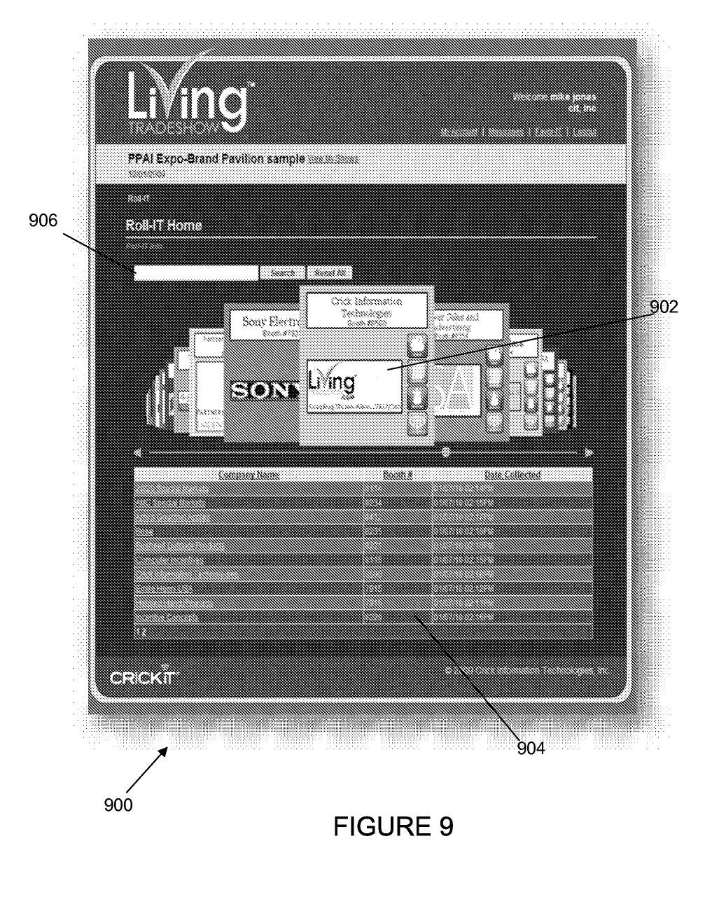

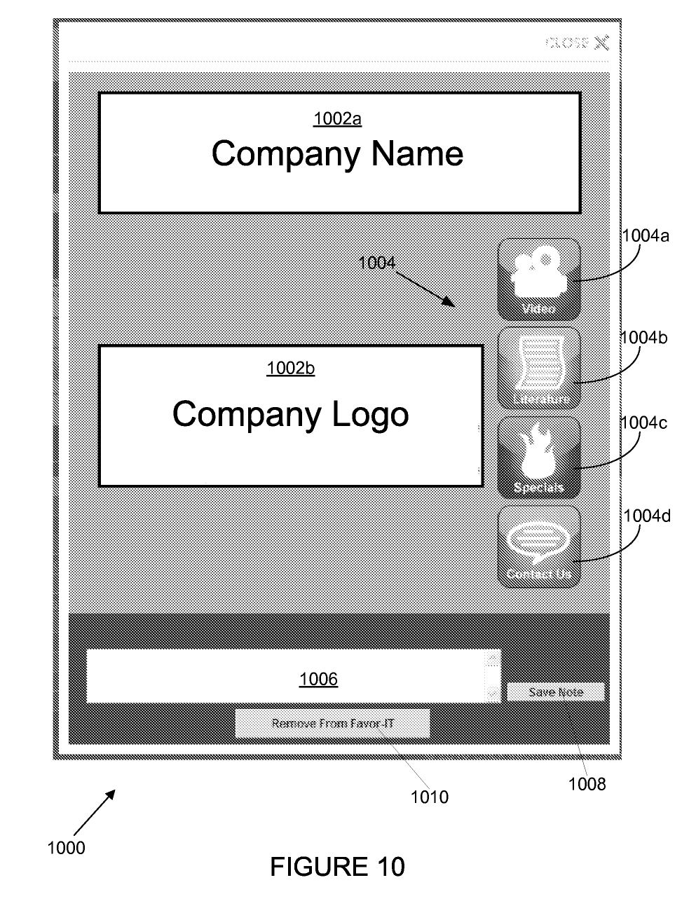

In accordance with these methods and systems, the computer-generated event floor (e.g., as in FIGS. 7 and 9, below) and the computer-generated exhibit (e.g., as in FIGS. 8 and 10) of the present disclosure can be presented to a user (e.g., and attendee) for interaction, and information about that interaction with the virtual exhibits can be provided to the exhibitors associated with those exhibits.

Generally, FIG. 4 illustrates an overall method for organizing and operating a virtual event in the context of a “living” event, according to a possible embodiment of the present disclosure. The method can be performed, for example, by an administrator of the event server 160 of FIGS. 1-2, above, or an event coordinator. The method 400 is instantiated at a start operation 402, which corresponds to initial election to associate a particular event with a virtual event using an event server, such as server 160 of FIGS. 1-2.

A setup operation 404 corresponds to physical setup of an event by an event organizer and/or an exhibitor. An example setup is illustrated in FIG. 1, above. An identifier assignment operation 406 assigns an identifier to each exhibit at the event. In various embodiments, the identifier assignment operation 406 can include associating a particular numerical code with an exhibit, or associating a bar code or other graphic with the exhibit as described above with respect to FIG. 1. A device identifier assignment operation 408 assigns an identifier to a device, thereby uniquely associating the device with a user. For example, the device identifier assignment operation 408 can occur in the context of a registration kiosk, a registration table, or can be performed as part of a log in process in a mobile web application. A link operation 410 optionally associates the identifier with a user in the event server 160, for example where the communications device is not previously associated with a user (e.g., where the communications device is issued to the attendee at the physical event).

A selection operation 412 corresponds to receiving selection of one or more exhibits at the event from an attendee (e.g., attendee 105 of FIG. 1). In certain embodiments, the selection operation 412 corresponds to receiving selection by the attendee, for example by way of a data exchange operation as described above, and linking the attendee and the identifier of the attendee's communication device (as determined by operations 408-410) with an identifier of the exhibit (as assigned in the identifier assignment operation 406) to associate that selected exhibit with the attendee.

Following the event, a display operation 414 corresponds to display of the event and associated exhibits and information for each exhibit in a virtual event environment, such as is illustrated in FIGS. 7-11. The display operation 414 can retrieve the virtual exhibit from the event server 160 for display to a user in a web portal or other web-based application.

The display operation 414 can also correspond to display of attendee access information to exhibitors, allowing exhibitors to review which attendees have viewed the virtual event associated with that exhibitor, as well as the particular information reviewed by the attendee. Example user interfaces enabling this display are discussed below in connection with FIGS. 12-13.

An end operation 416 corresponds to completed association of physical and virtual events with attendees and exhibitors using an event server (e.g., expiration of time after the event).

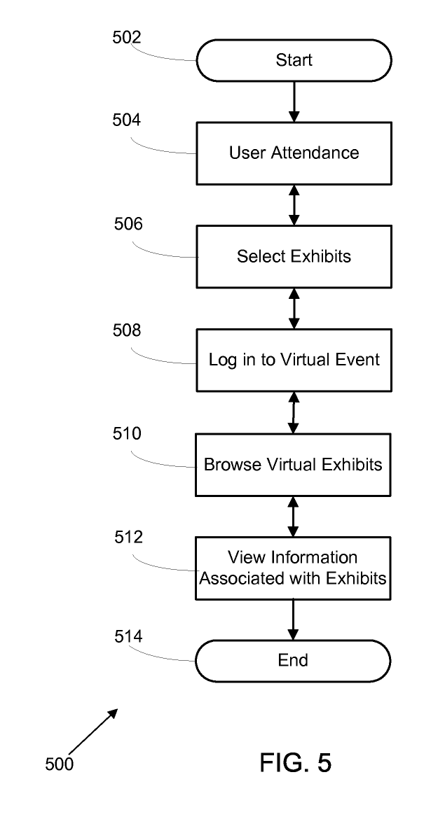

Referring now to FIG. 5, a method 500 for attendee interaction with a living event environment is described, including both physical and virtual event environments. The method 500 is instantiated at a start operation 502, which corresponds to initial attendee arrival at a physical event. An attendance operation 504 corresponds to attendance at an event by an attendee/user. In such embodiments, the attendance operation 504 includes various actions by the attendee at the conference, such as registration and association of a communication device with that attendee, using one of the methods and devices described above.

An exhibit selection operation 506 corresponds generally to the attendee actuation of the data exchange operation performed by the selection operation 412 of FIG. 4 while at the event, such as by actuating communication between a communication device (e.g., device 110) and an event server (e.g., event server 160) or a data exchange device (e.g., device 145). It is recognized that the exhibit selection operation 506 can correspond to selection of one or more exhibits associated with a particular event. Following exhibit selection, the attendee will typically complete his/her physical event experience.

A virtual event login operation 508 typically occurs after an event, and corresponds to the user providing sign-in credentials to the event server to access one or more events with which that user is associated. In certain embodiments, the virtual event login operation 508 results in display of an event user interface, such as illustrated in FIGS. 7-11, described below. A browse operation 510 corresponds to user browsing among the various exhibits available with respect to a particular selected event, as further described below. A selection operation 512 corresponds to selecting one or more of the exhibits, to view information associated with that exhibit. The selection operation 512 can correspond, in certain embodiments, to the user clicking on a particular exhibit, or viewing certain information associated with the exhibit. In association with the selection operation 512, a variety of different types of information can be presented to the attendee, depending upon the type of event that attendee visited. For example, in the case of a trade show event or other corporate event, various marketing materials or specification documents could be provided in electronic form (e.g., as a word processing or published document) in a readable format. Other example content could include informational videos (e.g., in a variety of formats, such as AVI, MOV, or others), contact cards (e.g., in VCF format or otherwise). In other contexts, such as a seminar or class, or in the case of a permanent exhibit (e.g., at a zoo or museum) analogous content could be provided.

In certain embodiments, the selection operation 512 preferably results in an event server storing attendee interactions with the exhibit information as associated with the attendee, for example for feedback to an exhibitor associated with that exhibit (as provided in FIG. 6, below). An end operation 514 corresponds to the attendee's completed interaction with the living event environment.

It is understood that certain of the above operations can be repeated, for example any of operations 508-512 occurring after attendance of the physical event. Furthermore, an attendee may elect to view information relating to more than one event or more than one exhibit, and therefore the event server 160 can store information regarding multiple exhibits or events per user (e.g. in the user account information 162 of FIG. 2). Additional embodiments are possible as well.

Referring now to FIG. 6, a method 600 for exhibitor interaction with a living event environment is described, including interacting with an event server in both physical and virtual event environments. The method 600 is instantiated at a start operation 602, which corresponds to initial registration of the exhibitor on the event server, for example in advance of an event at which the related exhibit is to be displayed. An exhibitor login operation 604 corresponds to the exhibitor accessing the event server 160 prior to the event occurring. A layout operation 606 corresponds to the exhibitor creating a virtual exhibit containing the various information that the exhibitor wishes to make available to attendees who select that virtual exhibit for later review. As explained above, the layout operation 606 can correspond to selection of one or more predefined options or templates illustrating a typical appearance of an exhibit. The layout operation 606 defines an arrangement of a virtual exhibit, such as the name, appearance, logo, and information associated with an exhibit. In alternative embodiments, the layout operation 606 receives custom layouts from the exhibitor for storage in the exhibitor information 164 of the event server, as described above with respect to FIG. 2.

An interaction operation 608 corresponds to the exhibitor's attendance at the physical event, and includes interaction to interest attendees and to receive data exchange operations (e.g., in the case where a data exchange device 145 is used). Optionally, the interaction operation 608 corresponds to collection of information about attendees, such as electronic information received at a data exchange unit communicatively connected to an event server and associated with an exhibit. Following the physical event, an information receipt operation 610 corresponds to receipt of information regarding user interest in the corresponding virtual exhibit, for example when the users access information made available at the virtual exhibit stored on the event server 160. The information receipt can take any of a number of forms, such as receipt of an email or viewing a user interface in a web portal, such as shown in FIGS. 12-13, below. An optional interested user contact operation 612 corresponds to the exhibitor making contact with those attendees exhibiting interest in the exhibit.

An end operation 614 corresponds to completed delivery of a virtual exhibit, and receipt of feedback regarding the effectiveness of the physical and/or virtual exhibits.

Referring to FIG. 6 generally, it is understood that additional operations are possible as well, and the operations disclosed can be performed in alternative orders. For example, an exhibitor can edit the virtual exhibit to add more information during or after the physical event takes place based on feedback received at or after the event. Other arrangements and operations are possible as well.

Referring now to FIGS. 7-13, various user interfaces are shown which can be displayed to attendees and exhibitors associated with a particular event, for example the attendee 202 and exhibitor 204 of FIG. 2, above. In general, the user interfaces illustrated in FIGS. 7-11 relate to presentation of a virtual exhibit and associated information to a user/attendee, while the user interfaces of FIGS. 12-13 relate to presentation of information regarding contact leads useable by an exhibitor. Using these interfaces, the attendees can browse through and view up-to-date information available at the event server 160 as provided by an exhibitor or presenter, while the exhibitor can view accesses by the attendee to gauge interest of that attendee in the materials provided, including possible products and services that could be offered to that attendee.

FIG. 7 illustrates an example virtual event user interface 700 generated from user selections at the physical event location, useable as a virtual representation of an event of the present disclosure. As illustrated in FIG. 7, the attendee also has the ability to scroll through the exhibits they selected when in person at the event. In the embodiment shown, the selection can be performed either using a graphical depiction of an event layout 702, or through a text-based menu 704 (i.e. the “Booth Directory”). The text-based menu 704 can, in such an embodiment, include the name of the company and the exhibit number and the attendee will be able to search for a company using various formats. An announcements menu 706 allows display of current event or exhibit announcements. Additionally, advertisements 708 or other items, such as a guided tour 710 can be added to the user interface. Optionally, an alternative navigation area, illustrated as a guide area 712 allows a user to view a displayed list of exhibitors by topic, as well as to perform a search of the selected exhibitors to find a relevant virtual exhibit.

In certain embodiments, the virtual event user interface 700 displays the virtual exhibits in the order selected by the attendee, to represent the layout of the physical event as it was experienced by the attendee. As such, the interface 700 is also scrollable to allow the attendee to “walk” through the virtual event from exhibit to exhibit. However, in preferred embodiments, the attendee will, in the virtual event, only view those exhibits which they previously expressed interest (i.e., using a data exchange operation as described above). In other embodiments (such as in the example of FIG. 5, below), alternative layouts can be used.

FIG. 8 illustrates a virtual exhibit user interface 800 included in the virtual representation of the event as illustrated in FIG. 7. The virtual exhibit user interface 800 is typically created by an exhibitor to represent a “virtual” version of the exhibit as it would appear to an attendee at an event. In certain embodiments, to design a particular exhibit an exhibitor can choose from ‘x’ booth templates, based on a three-dimensional presentation guiding that exhibitor through the design process. The computer-generated exhibit templates are customizable (color, buttons, etc). The exhibitor has the ability to upload video, documents, and other information as well, which will be included within each virtual exhibit and can be provided to users.

In various embodiments, an attendee can navigate to the virtual exhibit user interface 800 by selecting the exhibit graphic in the event layout 702 of the computer-generated event user interfaces of FIG. 7 or 9, or by selecting that exhibit from the text-based menu 704 or 904 of FIG. 7 or 9. Other possibilities exist as well.

In certain embodiments, the data exchange system (e.g., system 145 of FIG. 1) can also communicate with the event server 160, to retrieve, store and display the virtual version of the physical exhibit, as illustrated on user interface 800. In such embodiments, during the actual exhibit the virtual exhibit can be displayed using user interface 700 at the location of the exhibit or event. The virtual exhibit can be, in such embodiments, uploaded to the data exchange system along with the exhibitor's booth number and the company name from the event server for display.

In the embodiment shown, the user interface 800 includes a virtual exhibit display area 802, as well as a plurality of information selection options. The virtual exhibit display area 802 provides a virtual representation of the exhibit, and can include a logo 802a or other graphical element 802b representing the subject matter of the exhibit.

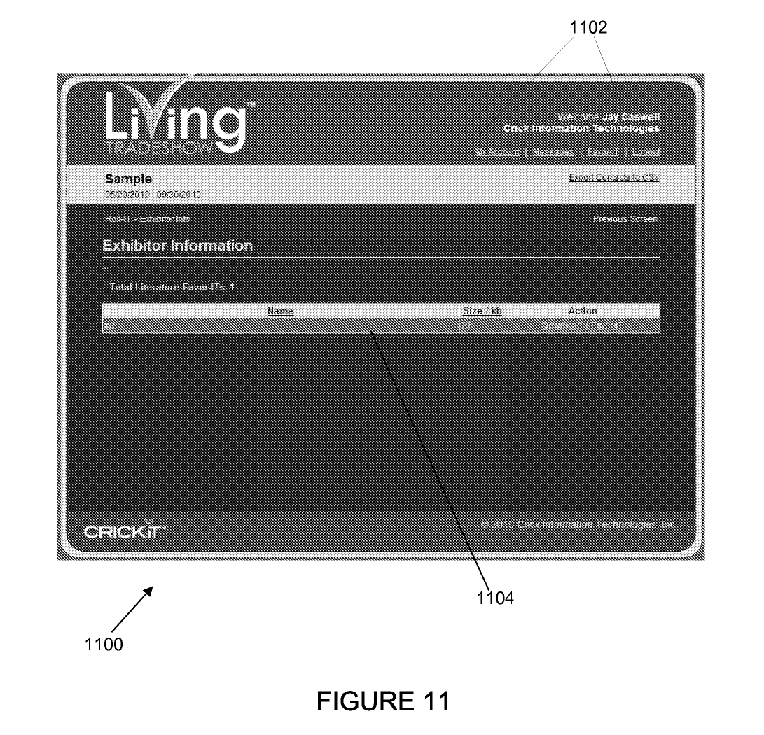

In the embodiment shown, the information selection options include an information button 804, a contact button 806, and a live connection button 808. The information button 804 can link the user to additional information associated with the exhibit, such as electronic copies of flyers or other information. In certain embodiments, the information button 404 leads a user to a user interface allowing that user to view available files for viewing, and to select one or more of those files for viewing and/or download. One example such screen is described below in connection with FIG. 11. The contact button 406 provides a display of contact information associated with the particular exhibit, for example to be used in the case of a trade show or other event at which different exhibitors gather, or to contact a presenter at a seminar. The live connection button 708 allows the user to connect to a live individual, for example at a call or help center, and to communicate specific questions associated with the exhibit.

Referring now to FIG. 9, a further example computer-generated user interface 900 is shown, representing an alternative embodiment of the virtual event user interface 700 of FIG. 7. In the embodiment shown, the user interface 900 includes a graphical layout 902 and a text-based menu 904. In such an embodiment, selection of either a graphical element or text-based element results in display of information associated with a particular exhibit, for example using the user interface 700 of FIG. 7. As compared to FIG. 7, the graphical layout 902 provides a “cover flow” arrangement in which a user can navigate among the various exhibits that they selected, either for a single event or for all events attended by that user. A search field 906 allows a user to perform a textual search through all of the available exhibits associated with a particular event.

FIG. 10 shows a virtual exhibit user interface 1000, according to a further possible embodiment of the present disclosure. The user interface 1000 can, in certain embodiments, represent a portion of interface 900, such as the graphical layout 902. In the embodiment shown, the virtual exhibit user interface 1000 includes a header 1002a and logo area 1002b, which are customizable by the exhibitor to present a particular appearance. Optionally, the exhibitor can also customize background colors or other appearance attributes illustrated in the interface 1000. The user interface 1000 includes a plurality of buttons 1004 leading to further information about the exhibit. In the embodiment shown, the buttons include a video button 1004a, a literature button 1004b, a specials button 1004c, and a contact button 1004d. Each of the buttons 1004 leads to a further user interface configured to display relevant information to that particular topic. One example such user interface is provided in FIG. 11.

Additionally, a text field allows the attendee to enter notes about the exhibit, so that the attendee can remember particular information about the exhibit or individuals at the exhibit. A save button 1008 allows the user to save the notes entered. A remove button 1010 allows the user to remove the virtual exhibit from the selected group of displayed exhibits associated with their personal virtual event, for example so that the event is removed from the graphical layout 902 of the event user interface 900.

Referring now to FIG. 11, a user interface 1100 presenting information accessible from a virtual exhibit is shown, according to a possible embodiment of the present disclosure. The user interface 1100 displays information available from a particular exhibitor, for example as related to a specific event at which an attendee selected an exhibit from the exhibitor. The user interface 1100 includes header information 1102 displaying the current attendee, as well as the event and exhibitor to which the information relates. Optionally, the header information 1102 can be editable (e.g., in the case of the information about the attendee) or downloadable (e.g. the exhibitor's contact information, as illustrated by the “Export Contacts to CSV” option). A listing of information 1104 is also displayed, and includes information downloadable by the attendee for viewing and saving.

Although in the embodiment shown only a single file is available for download and viewing in the listing of information 1104, it is understood that additional information could be included as well.

Referring now to FIGS. 12-13, user interfaces for providing exhibitor feedback regarding attendee interest are displayed, according to a possible embodiment of the present disclosure. FIG. 12 illustrates a user interface 1200 presenting an exhibitor contact management system, according to a possible embodiment of the present disclosure. The user interface 1200 includes header information 1201, generally describing the particular exhibitor and information associated with that exhibitor (for example, the events attended by the exhibitor and exhibits associated with the exhibitor). The user interface 1200 also includes a graphical region 1202 including a “cover flow” style contact manager, through which graphical cards can be scrolled to locate a desired contact. A search field 1204 allows the exhibitor to search for a particular contact, and a listing field 1206 lists each of the contacts included. The specific list of contacts included in the user interface 1200 can be defined in a number of ways. For example, the contacts can correspond to those attendees who have selected at least one exhibit associated with the exhibitor, or can also include contacts manually entered by the exhibitor. Other methods of associating attendees and exhibitors for inclusion in the user interface 1200 are possible as well.

FIG. 13 illustrates the user interface 1200 of FIG. 12, including an additional contact validation information screen 1300, according to a possible embodiment of the present disclosure. The contact validation screen 1300 is displayed upon selection of one of the contacts displayed in the listing field or 1206 or graphical region 1202 of the user interface 1200. The contact validation screen 1300 includes header information 1302 defining the contact, including the contacts name and contact information. The screen 1300 also includes a notes field allowing the exhibitor to generate internal notes regarding actions to take or actions taken with respect to that contact, such as past orders, past conversations, or other information. Optionally the notes field 1304 includes a set of predefined options 1306 for actions to take with respect to the particular contact. In the embodiment shown, a variety of contact actions are listed, such as adding the contact to a mailing list, providing pricing, quotes, or sales literature or samples to the contact.

A lead information field 1308 includes a listing of information describing instances in which the contact/attendee showed interest in the information available from the exhibitor. For example, the lead information field 1308 includes, in the embodiment shown, a field illustrating when the contact/attendee visited a booth (exhibit) associated with the exhibitor, as well as a field illustrating a time at which the contact was qualified (e.g., when the attendee subsequently logged in to the event server and accessed the virtual exhibit associated with the exhibitor). Additional information regarding specific materials viewed and times at which they were viewed and/or downloaded can be included as well.

Overall, the user interface screens of FIGS. 12-13 allow integration of contacts made at events, such as trade shows or other events, with an exhibitor's contact management system to allow integration of contacts from events into a system that allows the exhibitor to manage the method and timing of contacting potentially interested attendees. This has a number of advantages in different contexts. For example, in the case of trade shows, this allows an exhibitor to only contact those individual attendees who have shown some level of interest in a trade show exhibitor's products/services, because the exhibitor could elect to contact each attendee, each qualified attendee, or each qualified attendee who has also viewed some specific piece of product literature (e.g., to discuss specific features discussed in that literature). In other contexts, the user interface screens 1200-1300 of FIGS. 12-13 allow exhibitors to receive feedback regarding the number of attendees who have shown interest in the exhibit, and to provide a mechanism to determine what information available to the attendees appears most compelling. Exhibitors can adjust the materials available to attendees during or even after the event based on this information.

Referring back to FIG. 1-13 generally, it is seen that the systems and methods of the present disclosure concurrently provide event organizers with a closed-loop, web-based user information capture system. As is evident from the following disclosure, the systems and methods described herein increase qualified lead generation (identification of interested users) and extend the effective life of an exhibit or event experience from hours to months. The systems and methods of the present disclosure concurrently allow attendees to collect information regarding topics of interest, with event organizers allowed to provide subsequent contacts or materials based on after-event information access tracking features.

The above specification, examples and data provide a complete description of the manufacture and use of the composition of the invention. Since many embodiments of the invention can be made without departing from the spirit and scope of the invention, the invention resides in the claims hereinafter appended.

1. A method of delivering a virtual exhibit to an attendee of a physical event, the method comprising:
receiving an indication of interest from an attendee that identifies at least one physical exhibit at an event, the indication of interest including an identifier associated with the attendee;
storing an association between the attendee and the exhibit;
receiving a request from the attendee to view a virtual event; and
displaying the virtual event to the attendee, the virtual event including a virtual exhibit corresponding to the at least one physical exhibit.

2. The method of claim 1, further comprising:
receiving selection of the virtual event from the attendee; and
storing interactions between the virtual event and the attendee

3. The method of claim 2, further comprising:
communicating the interactions between the virtual event and the attendee to an exhibitor associated with the virtual exhibit.

4. The method of claim 3, wherein the exhibitor associated with the virtual exhibit is an exhibitor associated with the at least one physical exhibit.

5. The method of claim 1, wherein receiving an indication of interest comprises receiving a data communication operation at an event server.

6. The method of claim 5, wherein receiving the indication of interest comprises receiving an image of a bar code at the event server from a communications device associated with the attendee.

7. The method of claim 6, wherein the communications device is a cellular telephone.

8. The method of claim 5, wherein receiving the indication of interest comprises receiving an identifier of the attendee from a data exchange device associated with the exhibit.

9. The method of claim 1, wherein the physical event is an event selected from the group consisting of:
a trade show event;
a corporate event;
a seminar;
a zoo;
an amusement park; and
a museum;

10. A method of viewing a virtual exhibit comprising:
attending a physical event at which a plurality of physical exhibits reside;
while attending the physical event, electronically actuating a communication to an event server, the communication associating an event attendee with the physical exhibit;
accessing a virtual event in a web application generated by the event server, the virtual event corresponding to the physical event;
viewing a virtual exhibit associated with the virtual event, the virtual exhibit representing the physical exhibit selected by the communication.

11. The method of claim 10, further comprising electronically actuating a plurality of communications to the event server, wherein each communication associated the event attendee with one of a plurality of physical exhibits.

12. The method of claim 11, further comprising, upon accessing the virtual event, viewing a plurality of virtual exhibits corresponding to the plurality of physical exhibits.

13. The method of claim 12, wherein the virtual event displays a representation of the physical event corresponding to the order in which the plurality of virtual exhibits were selected by the event attendee.

14. The method of claim 10, wherein electronically actuating a communication comprises actuating a data exchange operation between a communications device associated with the event attendee and a data exchange device associated with the physical exhibit.

15. The method of claim 10, wherein electronically actuating a communication comprises transmitting an image associated with the physical exhibit to the event server from a cellular telephone associated with the event attendee.

16. A method of providing virtual event information to event exhibitors, the method comprising:
designing, using an event server, a virtual exhibit associated with a physical exhibit;
providing the physical exhibit at a physical event, the physical exhibit including an identifier of the exhibit and visited by event attendees; and
receiving information from the event server describing interactions with the virtual exhibit by the event attendees.

17. The method of claim 16, wherein the physical event is an event selected from the group consisting of:
a trade show event;
a corporate event;
a seminar;
a zoo;
an amusement park; and
a museum;

18. The method of claim 16, further comprising contacting one or more of the event attendees based on the information received from the event server describing interactions with the virtual exhibit.

19. The method of claim 16, wherein receiving information from the event server comprises viewing a contact management user interface describing qualified contacts by event attendees.

20. The method of claim 16, further comprising defining one or more actions to be taken with respect to the event attendees.
